(19) United States
(12) Patent Application Publication
(10) Pub. No.: US 2017/0288229 A1
(43) Pub. Date: Oct. 5, 2017

(54) SULFUR BASED CATHODE COMPOSITE MATERIAL AND METHOD FOR MAKING THE SAME

(71) Applicants: Jiangsu Huadong Institute of Li-Ion Battery Co., Ltd., Suzhou (CN); Tsinghua University, Beijing (CN)

(72) Inventors: Li Wang, Beijing (CN); Xiang-Ming He, Beijing (CN); Yu-Mei Ren, Suzhou (CN); Jian-Jun Li, Beijing (CN); Fang-Xu Wu, Beijing (CN); Yu-Ming Shang, Beijing (CN); Yuan-Qing Li, Suzhou (CN); Tuan-Wei Li, Suzhou (CN); Shu-Hui Wang, Suzhou (CN)

(73) Assignees: Jiangsu Huadong Institute of Li-Ion Battery Co., Ltd., Suzhou (CN); Tsinghua University, Beijing (CN)

(21) Appl. No.: 15/627,276

(22) Filed: Jun. 19, 2017

Related U.S. Application Data
(63) Continuation of application No. PCT/CN2015/096805, filed on Dec. 9, 2015.

(30) Foreign Application Priority Data
Dec. 19, 2014 (CN) 201410795069.8

(51) Int. Cl. H01M 4/60; H01M 4/36; C08F 120/44; C08J 3/20; C08K 3/04; H01M 4/38; H01M 4/62

(52) U.S. Cl. CPC H01M 4/602; H01M 4/38; H01M 4/362; H01M 4/625; C08J 3/203; C08K 3/041; C08F 120/44; H01M 2004/028

(57) ABSTRACT

A method for making a sulfur based cathode composite material is disclosed. Polyacrylonitrile and elemental sulfur are dissolved together in a first solvent to form a first solution. An electrically conductive carbonaceous material is added to the first solution to mix with the polyacrylonitrile and the elemental sulfur. An environment in which the polyacrylonitrile and the elemental sulfur are located in is changed to reduce a solubility of the polyacrylonitrile and the elemental sulfur in a changed environment to simultaneously precipitate the polyacrylonitrile and the elemental sulfur, thereby forming a precipitate having the electrically conductive carbonaceous material. The precipitate is heated to chemically react the polyacrylonitrile with the elemental sulfur. A sulfur based cathode composite material is also disclosed.

### CROSS-REFERENCE TO RELATED APPLICATIONS

This application claims all benefits accruing under 35 U.S.C. §119 from China Patent Application No. 201410795069.8, filed on Dec. 19, 2014 in the State Intellectual Property Office of China, the content of which is hereby incorporated by reference. This application is a continuation under 35 U.S.C. §120 of international patent application PCT/CN2015/096805 filed on Dec. 9, 2015, the content of which is also hereby incorporated by reference.

### FIELD

The present disclosure relates to cathode materials and method for making the same, and particularly relates to sulfur based cathode composite materials of lithium ion batteries and method for making the same.

### BACKGROUND

Polyacrylonitrile (PAN) is a high molecular weight polymer composed of saturated carbon skeleton containing cyano groups (CN) on alternate carbon atoms. PAN itself is not electrically conductive but can be sulfurized to form sulfurized polyacrylonitrile, which is electrically conductive and chemically active. Specifically, the PAN powder and elemental sulfur are mixed to form a mixture, which is then heated and completely reacted at 300° C., to form sulfurized polyacrylonitrile. The sulfurized polyacrylonitrile can be used as a cathode material of a lithium ion battery. The PAN may have a sulfurization and a cyclization reaction during the process of forming the sulfurized polyacrylonitrile. Thus, the sulfurized polyacrylonitrile is a conjugated polymer having long-range n-type bonds. The sulfurized polyacrylonitrile used as the cathode material of the lithium ion battery has a high specific capacity.

### SUMMARY

One aspect of the present disclosure is to provide a method for making a sulfur based cathode composite material by uniformly mixing the PAN with the sulfur.

A sulfur based cathode composite material is a ternary composite material, comprising a dehydrocyclization product of polyacrylonitrile, an elemental sulfur, and an electrically conductive carbonaceous material.

A method for making a sulfur based cathode composite material comprises: co-dissolving PAN with elemental sulfur in a first solvent to form a first solution; adding an electrically conductive carbonaceous material in the first solution to mix with the dissolved PAN and the elemental sulfur; varying an environment of the PAN and the elemental sulfur to simultaneously precipitate the PAN and the elemental sulfur, and due to a solubility decrease in the changed environment, a precipitate with the electrically conductive carbonaceous material is formed; and heating the precipitate to chemically react the PAN with the elemental sulfur to dehydrocyclizate the PAN with the elemental sulfur to form the sulfur based cathode composite material.

In the method for making the sulfur based cathode composite material, by dissolving the PAN and the elemental sulfur, uniform mixing in the liquid phase can be achieved. The solubility is reduced to simultaneously precipitate the two to form the uniform solid mixture, which is conducive to reaction between the PAN and the elemental sulfur in the subsequent heat treatment process.

### BRIEF DESCRIPTION OF THE DRAWINGS

Implementations are described by way of example only with reference to the attached figures.

FIG. 1 is a flow chart of one embodiment of a method for making a sulfur based cathode composite material.

FIG. 2 is a graph showing a Scanning Electron Microscope (SEM) image of a precipitate obtained in Example 1 of the method for making the sulfur based cathode composite material.

FIG. 3 is a graph showing a second charge-discharge curve of a lithium ion battery prepared from the sulfur based cathode composite material obtained in Example 1.

FIG. 4 is a graph showing a cycle performance test curve of the lithium ion battery prepared from the sulfur based cathode composite material obtained in Example 1.

### DETAILED DESCRIPTION

Numerous specific details are set forth in order to provide a thorough understanding of the embodiments described herein. However, it will be understood by those of ordinary skill in the art that the embodiments described herein can be practiced without these specific details. In other instances, methods, procedures, and components have not been described in detail so as not to obscure the related relevant feature being described.

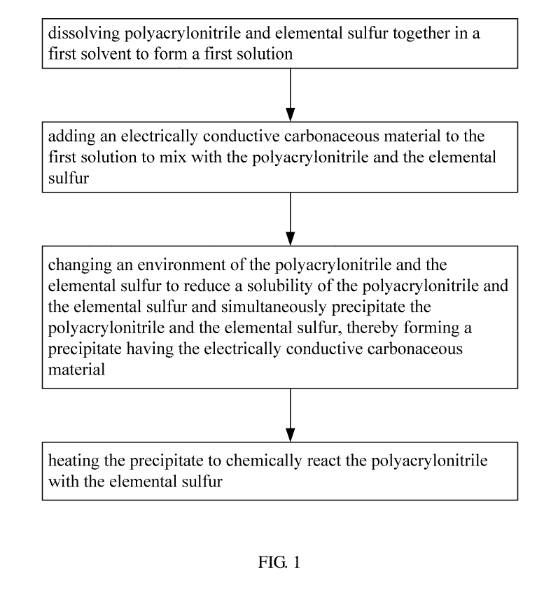

Referring to FIG. 1, an embodiment of a method for making a sulfur based cathode composite material comprising:

S1, dissolving polyacrylonitrile (PAN) and elemental sulfur together in a first solvent to form a first solution;

S2, adding an electrically conductive carbonaceous material to the first solution to mix with the dissolved PAN and the dissolved elemental sulfur;

S3, changing an environment in which the PAN and the elemental sulfur are located in, the PAN and the elemental sulfur are simultaneously precipitated by changing the environment, and formed into a precipitate together with the electrically conductive carbonaceous material; and

S4, heating the precipitate to chemically react the PAN with the elemental sulfur to form the sulfur based cathode composite material.

In S1, the PAN and the elemental sulfur are proportionally dissolved in the first solvent having a temperature in the first temperature range to form the first solution. The first temperature range (T1) is greater than or equal to 100° C. and less than or equal to 200° C. (100° C.≦T1<200° C.). The elemental sulfur and the PAN, having a mass ratio of 1:1 to 10:1, can be completely dissolved in the first solvent. A total concentration of the PAN and the elemental sulfur in the first solution can be in a range from about 10 g/L to about 100 g/L. In one embodiment, the elemental sulfur and the PAN, having a mass ratio of 1:1 to 4:1, can be dissolved in the first solvent. A proper control of the total concentration of the first solution is advantageous for both the production of the precipitate and the uniform mixing of the PAN and the elemental sulfur.

The PAN can be a homopolymer of an acrylonitrile monomer or a copolymer of the acrylonitrile monomer and a second copolymerization unit. The second copolymerization unit can be selected from, but not limited to, at least one of methyl acrylate, methyl methacrylate, itaconic acid, dimethyl itaconate, and acrylamide. A molecular weight of the PAN is not limited, and is can be in a range from 30,000 to 150,000. The type of the first solvent is not limited as long as the PAN and the elemental sulfur are soluble to the first solvent in the first temperature range (the solubility can be greater than 1). The first solvent can be N-methylpyrrolidone, dimethylformamide, dimethylsulfoxide, dimethylacetamide or mixtures thereof. The first solvent is used to physically dissolve the elemental sulfur and the PAN, and does not chemically react with the elemental sulfur or the PAN.

In S2, the electrically conductive carbonaceous material can be in shape of powder or particles, and the particle size can be less than or equal to 10 microns, such as less than or equal to 5 microns, and in one embodiment less than or equal to 1 micron. The electrically conductive carbonaceous material can be an inorganic electrically conductive carbonaceous material, selected from but not limited to carbon nanotubes, graphenes, acetylene black, and carbon black. The electrically conductive carbonaceous material does not have a chemical reaction with the first solvent or the second solvent. A function of the electrically conductive carbonaceous material can be, but is not limited to:

(1) forming a uniform electrically conductive network to enhance a conductive property of the sulfur based cathode composite material;

(2) forming a small amount of sulfur-carbon composite during the heating of S4, the sulfur-carbon composite and the sulfurized polyacrylonitrile works as a sulfur-carbon double module to increase the sulfur amount in the sulfur based cathode composite material;

(3) absorbing polysulfide ions in charge and discharge processes of the sulfur based cathode composite material to reduce a loss of the active material; and

(4) reducing an impedance of the charge and discharge processes of the sulfur based cathode composite material by adding a small amount of the electrically conductive carbonaceous material.

An amount of the electrically conductive carbonaceous material is less than or equal to 10% of the total mass of the PAN and the elemental sulfur, such as less than or equal to 1% of the total mass of the PAN and the elemental sulfur.

The additive can be insoluble to the first solvent, and the electrically conductive carbonaceous material powder or particles can be uniformly dispersed in the first solvent by mechanical stirring or ultrasonic oscillation.

In one embodiment, the electrically conductive carbonaceous material can be added directly to the first solution. In another embodiment, the electrically conductive carbonaceous material can be separately dispersed in a small amount of the first solvent to form a dispersion, and then the dispersion is mixed with the first solution. The first solution after adding with the electrically conductive carbonaceous material can be maintained at a temperature in the first temperature range, i.e., 100° C. ≦T1≦200° C., regardless of whether or not the electrically conductive carbonaceous material is added in the form of the dispersion, and the total concentration of the PAN and the elemental sulfur is still in the range of 10 g/L to 100 g/L.

In S3, the mixture of the PAN, the elemental sulfur, and the electrically conductive carbonaceous material is transferred from a first environment to a second environment so that the solubilities of both the PAN and the elemental sulfur are reduced such that the PAN and the elemental sulfur are able to precipitate and become a solid precipitation from the dissolved state. An amorphous elemental sulfur or the elemental sulfur with a lower crystallinity can be obtained by reducing the solubility and precipitating the elemental sulfur, which is conducive to improve the electrochemical performance of the sulfur based cathode composite material. In addition, the simultaneous precipitation of the PAN and the elemental sulfur in the second environment is a physical precipitation process due to the decrease of the solubility. It is not the PAN and the elemental sulfur formed by chemical reaction in this process. In addition, the electrically conductive carbonaceous material can remain as solid powder or particles from the first environment to the second environment. The precipitated solid PAN is homogeneously mixed with the elemental sulfur and the electrically conductive carbonaceous material. The final precipitated substance obtained in S3 comprises uniformly mixed PAN, elemental sulfur, and electrically conductive carbonaceous material. In one embodiment, the PAN is coated on the surface of the elemental sulfur. The particle size of the precipitate can be less than or equal to 10 microns.

The first environment can be a first solvent capable of dissolving the PAN and the elemental sulfur at a predetermined temperature and pressure. The temperature of the first environment can be in the first temperature range, and the pressure of the first environment can be atmospheric pressure. Since the solubility of the substance is related to the type of solvent and the temperature and pressure at which the substance is dissolved, the solubility of the PAN and the elemental sulfur can be reduced by at least one of: (1) changing the type of solvent; (2) changing the temperature; and (3) changing the pressure. That is, the second environment has at least one of the three above-described changed conditions compared to the first environment.

(1) Example for changing the solvent:

In one embodiment of S3, the first solution containing the electrically conductive carbonaceous material is transferred to the second solvent, and the PAN and the elemental sulfur are simultaneously precipitated as a solid precipitate together with the electrically conductive carbonaceous material. The solubility of the elemental sulfur in the second solvent is smaller than in the first solvent. The solubility of the PAN in the second solvent is smaller than in the first solvent. The additive can be insoluble in the second solvent or less soluble in the second solvent than in the first solvent. In one embodiment, the PAN, the elemental sulfur, and the electrically conductive carbonaceous material are insoluble in the second solvent.

The transfer process can be accompanied with agitation or oscillation, so that the two solvents are fully and uniformly mixed. The temperature can be further varied while changing the solvent. In particular, the first solution having the first temperature in the first temperature range and containing the electrically conductive carbonaceous material can be added to the second solvent having the second temperature in the second temperature range, and the second temperature is lower than the first temperature. The temperature difference between the first temperature and the second temperature can be greater than or equal to 50° C. The second temperature range (T2) can be smaller than or equal to 50° C. (T2≦50° C.) and greater than the freezing points of the second solvent and the first solvent. Since the first solution is added to the second solvent to have the first solvent mixed with the second solvent, in order to reduce the solubilities of the PAN and the elemental sulfur more significantly in the mixed solvent, a volume ratio of the first solvent to the second solvent can be 1:1 to 1:5. The type of the second solvent is not limited as long as the PAN, the elemental sulfur, and the electrically conductive carbonaceous material are insoluble in the second solvent in the second temperature range. The second solvent can be water, ethanol, methanol, acetone, n-hexane, cyclohexane, diethyl ether, or mixtures thereof. The time used for completing the transfer of the first solution to the second solvent can be controlled within 10 seconds to have a rapid precipitation. Otherwise, the PAN and the elemental sulfur are sufficiently agitated or stirred during the transfer to cause the rapid precipitation. The rapid precipitation can result in a uniform coating of the PAN on the surface of the elemental sulfur to form a core-shell structure, which facilitates the reaction of PAN with the elemental sulfur during the subsequent heating, while also prevents the loss of the elemental sulfur during the heating, and can reduce the corrosion caused by the elemental sulfur to the equipment.

The simultaneously precipitation of the PAN and the elemental sulfur in the second solvent is a physical precipitation process in which the solubilities of the PAN and the elemental sulfur originally dissolved in the first solvent are reduced by being transferred to the second solvent, thereby precipitating the solid substance, rather than through a chemical reaction to synthesize the PAN and the elemental sulfur. In addition, the electrically conductive carbonaceous material is insoluble in the first solvent, the electrically conductive carbonaceous material may remain as solid powder or particles during the transfer from the first solvent to the second solvent.

After S3, the method can further comprise a step of filtering out the precipitate from the second solvent.

(2) Example for changing the temperature:

In another embodiment of S3, the first solution in the first temperature range containing the electrically conductive carbonaceous material can be freeze-dried, and the PAN and the elemental sulfur are simultaneously precipitated to form a solid precipitate together with the electrically conductive carbonaceous material. The freeze-drying conditions are not particularly limited.

(3) Example for changing the pressure:

In yet another embodiment of S3, the first solution in the first temperature range containing the electrically conductive carbonaceous material is depressurized, to simultaneously precipitate the PAN and the elemental sulfur to form a solid precipitate together with the electrically conductive carbonaceous material.

In S4, the precipitate is heated in vacuum or a protective atmosphere at a temperature equal to or above 250° C., such as in a range from 300° C. to 450° C., and the heating time can be decided based on the amount of the precipitate, such as from 1 hour to 10 hours. The protective atmosphere can be at least one of an inert gas and a nitrogen gas.

In the heating process, the elemental sulfur as a catalyst can catalyze the dehydrogenation of the PAN to form a main chain similar to the polyacetylene structure, and the side chain, the cyano group, is cyclized to form a cyclized polyacrylonitrile having a structural unit

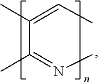

wherein n is an integer greater than 1. Furthermore, the cyclized polyacrylonitrile simultaneously reacts with the molten-state elemental sulfur to embed the elemental sulfur in the cyclized polyacrylonitrile to obtain a sulfurized polyacrylonitrile. The sulfur particles of elemental sulfur or sulfur group (SX) are covalently bonded to the C atom or the N atom in the structural unit

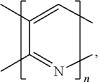

to form a structural unit such as

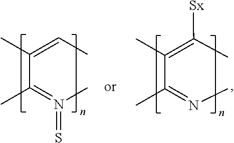

wherein n is an integer greater than 1, and x is not limited, such as an integer from 1 to 8. Other structural units may also be present in the molecule of the sulfurized polyacrylonitrile, depending on the heating conditions, such as the temperature.

The electrically conductive carbonaceous material can generate a small amount of sulfur-carbon composite material during the heating. In addition, the electrically conductive carbonaceous material can absorb polysulfide ions during the charging and discharging process of the sulfur based cathode composite material, thereby reducing the loss of the active material and improving the battery performance. Further, the electrically conductive carbonaceous material can form a uniform conductive network to improve the conductivity of the sulfur based cathode composite material. In charging and discharging of the sulfur based cathode composite material, a small amount of electrically conductive carbonaceous material is conducive to reduce the impedance of the charge and discharge.

One embodiment of the sulfur based cathode composite material is also provided. The sulfur based cathode composite material is a ternary composite material, comprising a dehydrocyclization product of the polyacrylonitrile, the elemental sulfur, and the electrically conductive carbonaceous material. In the sulfur based cathode composite material, a weight percentage of the dehydrocyclized polyacrylonitrile is 30% to 70%, a weight percentage of the elemental sulfur is 30% to 70%, and a weight percentage of the electrically conductive carbonaceous material is 1% to 20%.

### EXAM PLE 1

10 g of sublimed sulfur and 2 g of PAN are weighed, and dissolved in 200 mL of 120° C. oil-bathed N-methylpyrrolidone until the starting materials are completely dissolved to form the first solution. Uniformly dispersed carbon nanotubes are added to the first solution. A mass of the carbon nanotubes is 5% of the total mass of the sublimed sulfur and the PAN. The first solution containing the carbon nanotubes is rapidly transferred to 200 mL of ice-bathed acetone in 3 seconds to obtain the precipitate. The precipitate is dried in at 60° C. in vacuum. After drying, the precipitate is heated at 300° C. for 6 hours, and the product is the sulfurized polyacrylonitrile composite containing the carbon nanotubes.

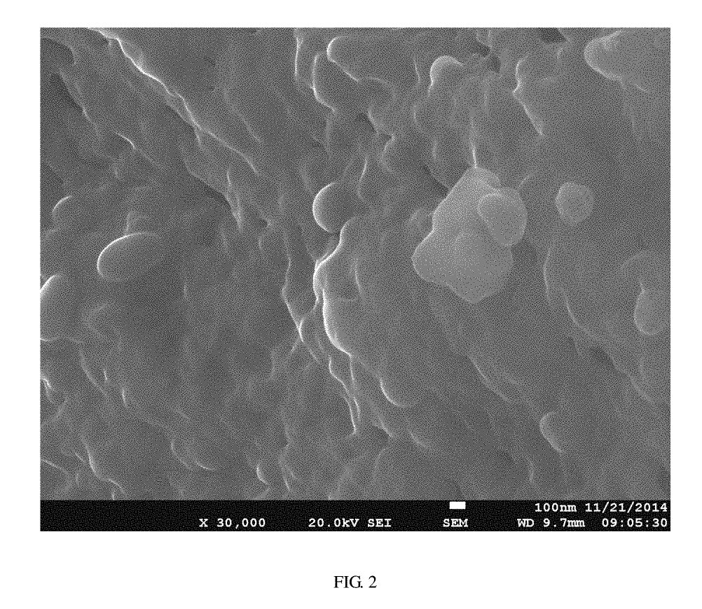

FIG. 2 is an SEM image of the precipitate obtained in Example 1. It can be seen from FIG. 2 that the PAN is uniformly coated on the surface of the elemental sulfur.

### COMPARATIVE EXAMPLE 1

Comparative Example 1 is similar to Example 1, without any electrically conductive carbonaceous material. Specifically, 10 g of sublimed sulfur and 2 g of PAN are weighed, and dissolved in 200 mL of 120° C. oil-bathed N-methylpyrrolidone until the starting materials are completely dissolved to form the first solution. The first solution is rapidly transferred to 200 mL of ice-bathed acetone in 3 seconds to obtain the precipitate. The precipitate is dried in at 60° C. in vacuum. After drying, the precipitate is heated at 300° C. for 6 hours, and the resulting product is the sulfurized polyacrylonitrile without the carbon nanotubes.

Lithium ion batteries are assembled respectively using the products of Example 1 and Comparative Example 1 as the cathode active materials. The electrochemical performances of the lithium ion batteries are tested. Specifically, 85% to 98% of the cathode active material, 1% to 10% of a conducting agent, and 1% to 5% of a binder by mass are mixed and coated on the surface of the aluminum foil as a cathode electrode. The lithium metal is used as an anode electrode. Lithium hexafluorophosphate (LiPF6) is dissolved in a mixed solvent of ethylene carbonate (EC) and methyl ethyl carbonate (EMC) in a volume ratio of 1: 1 to form an electrolyte having 1 mol/L of the LiPF6. The two lithium ion batteries are galvanostatic charged and discharged using a current rate of 0.1 C.

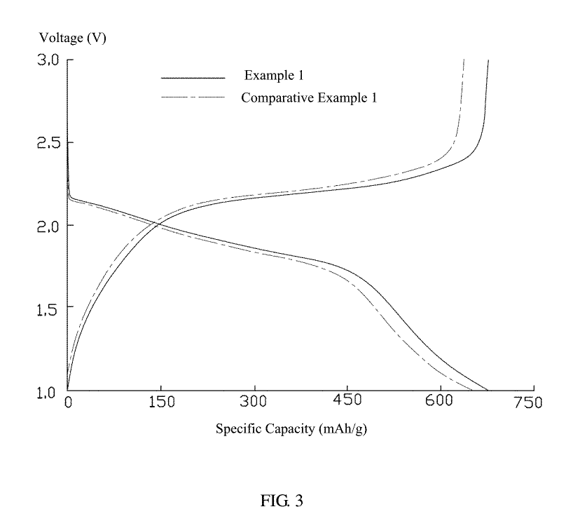

FIG. 3 is a graph showing charge and discharge curves at the second cycle of the two lithium ion batteries of Example 1 and Comparative Example 1. The discharge specific capacity (about 675 mAh/g) of the lithium ion battery of Example 1 is larger than the discharge specific capacity (about 640 mAh/g) of the lithium ion battery of Comparative Example 1 at the second cycle.

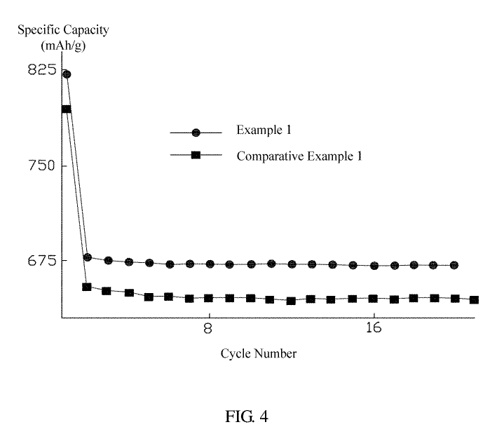

Referring to FIG. 4, the cycle performances of the two lithium ion batteries are shown in FIG. 4, and it can be seen that the specific capacity of the lithium ion battery of Example 1 is significantly higher than that of the lithium ion battery of Comparative Example 1, and after a plurality of cycles, the battery almost has no attenuation in specific capacity, showing a good cycle stability.

Finally, it is to be understood that the above-described embodiments are intended to illustrate rather than limit the present disclosure. Variations may be made to the embodiments without departing from the spirit of the present disclosure as claimed. Elements associated with any of the above embodiments are envisioned to be associated with any other embodiments. The above-described embodiments illustrate the scope of the present disclosure but do not restrict the scope of the present disclosure.

What is claimed is:

1. A sulfur based cathode composite material comprising a dehydrocyclized polyacrylonitrile, an elemental sulfur, and an electrically conductive carbonaceous material.

2. The sulfur based cathode composite material of claim 1, wherein a weight percentage of the dehydrocyclized polyacrylonitrile is about 30% to about 70%, a weight percentage of the elemental sulfur is about 30% to about 70%, and a weight percentage of the electrically conductive carbonaceous material is about 1% to about 20%.

3. The sulfur based cathode composite material of claim 1, wherein the electrically conductive carbonaceous material is selected from the group consisting of carbon nanotubes, graphenes, acetylene black, carbon black, and combinations thereof.

4. The sulfur based cathode composite material of claim 1, wherein a size of the electrically conductive carbonaceous material is less than or equal to 1 microns.

5. A method for making a sulfur based cathode composite material comprising:
dissolving polyacrylonitrile and elemental sulfur together in a first solvent to form a first solution;
adding an electrically conductive carbonaceous material to the first solution to mix with the polyacrylonitrile and the elemental sulfur;
changing an environment of the polyacrylonitrile and the elemental sulfur to reduce a solubility of the polyacrylonitrile and the elemental sulfur and simultaneously precipitate the polyacrylonitrile and the elemental sulfur, thereby forming a precipitate having the electrically conductive carbonaceous material; and
heating the precipitate to chemically react the polyacrylonitrile with the elemental sulfur.

6. The method of claim 5, wherein a shape of the electrically conductive carbonaceous material is powder or particles having a size less than or equal to 5 microns.

7. The method of claim 5, wherein a material of the electrically conductive carbonaceous material is selected from the group consisting of carbon nanotubes, graphenes, acetylene black, carbon black, and combinations thereof.

8. The method of claim 1, wherein an amount of the electrically conductive carbonaceous material is less than or equal to 10% of a total mass of the polyacrylonitrile and the elemental sulfur.

9. The method of claim 1, wherein the changing the environment comprises transferring the first solution to the second solvent, the polyacrylonitrile and the elemental sulfur are insoluble or less soluble in the second solvent than in the first solvent.

10. The method of claim 9, wherein the temperature of the second solvent is lower than the temperature of the first solution, and a temperature difference between the second solvent and the first solution is greater than or equal to 50° C.

11. The method of claim 9, wherein the first solution is greater than or equal to 100° C. and less than or equal to 200° C., the second solvent is smaller than or equal to 50° C.

12. The method of claim 9, wherein a volume ratio of the first solvent to the second solvent is about 1:1 to about 1:5.

13. The method of claim 9, wherein the second solvent is selected from the group consisting of water, ethanol, methanol, acetone, n-hexane, cyclohexane, diethyl ether, and mixtures thereof.

14. The method of claim 9, wherein a time used for completing the transferring of the first solution to the second solvent is within 10 seconds.

15. The method of claim 5, wherein a total concentration of the polyacrylonitrile and the elemental sulfur in the first solution is in a range from about 10 g/L to about 100 g/L.

16. The method of claim 5, wherein the changing the environment comprises freeze-drying the first solution.

17. The method of claim 5, wherein the changing the environment comprises depressurizing the first solution.

18. The method of claim 1, wherein the heating is in a vacuum or a protective atmosphere at a temperature equal to or above 250° C.

19. The method of claim 1, wherein the forming the precipitate is a physical process without a chemical synthesis of the polyacrylonitrile and the elemental sulfur.
